(19) United States
(12) Patent Application Publication
(10) Pub. No.: US 2012/0129439 A1
(43) Pub. Date: May 24, 2012

(54) AIR CONDITIONING SYSTEM FOR VEHICLE

(75) Inventors: Koji Ota, Kariya-city (JP); Manabu Maeda, Nagoya-city (JP)

(73) Assignee: DENSO CORPORATION, Kariya-city (JP)

(21) Appl. No.: 13/297,621

(22) Filed: Nov. 16, 2011

(30) Foreign Application Priority Data
Nov. 24, 2010 (JP) 2010-261159

(51) Int. Cl. B60H 1/24

(52) U.S. Cl. 454/120

(57) ABSTRACT

An air conditioning system for a vehicle includes a seat part having a seating surface and an air flow passage, an air conditioning unit, and a blower. The passage includes a suction port on the seating surface and an air outlet at a region of the seat part other than the seating surface. The unit includes a face air outlet and a lower air outlet through which conditioned air from the unit is blown out toward the seating surface. The blower forms a flow of air in the passage from the suction port toward the air outlet. At time of cooling vehicle interior by the unit, the conditioned air blown out of the lower outlet is suctioned from the seating surface, and air that has passed through the passage is blown out of the region of the seat part other than the seating surface.

### CROSS REFERENCE TO RELATED APPLICATION

This application is based on and incorporates herein by reference Japanese Patent Application No. 2010-261159 filed on Nov. 24, 2010.

### BACKGROUND OF THE INVENTION

1. Field of the Invention

The present invention relates to an air conditioning system for a vehicle including an air flow passage inside a seat.

2. Description of Related Art

For such an air conditioning system for a vehicle, an air conditioning system that includes a duct for guiding conditioned air from an air conditioning unit to a seat and that suctions cold air from the air conditioning unit into the seat through this duct to blow out the suctioned cold air from a seating surface of the seat is described in Japanese Patent No. 3633777 (corresponding to U.S. Pat. No. 5,921,100). In the early stage of a cooling-down period in summer, this system suctions cold air from the air conditioning unit having lower temperature than the vehicle interior into the seat, and then blows the cold air out of the seating surface of the seat, so as to seek to improve comfortableness for an occupant of the vehicle in summer.

A system that includes an air blow-out region at a central part of a seating surface of a seat backrest part and has an air suction region on a lateral side of the blow-out region is described in JP-A-2010-052494. In the early stage of the cooling-down period in summer, this system suctions air, which is not affected by heat mass (heat capacity) of the seat, from a side part of a body of an occupant of the vehicle seated on the seat, so as to seek to improve comfortableness for the occupant in summer.

However, both in the air conditioning systems for vehicles described in Japanese Patent No. 3633777 and JP-A-2010-052494, the air flowing through the inside of the seat is blown out from the seating surface of the seat. Accordingly, in the early stage of the cooling-down period in summer, the air flowing through the inside of the seat is influenced by the heat mass of the seat until the air flowing inside the seat reaches the seating surface of the seat. For this reason, the air, which is influenced by the heat mass of the seat, is supplied to the seating surface of the seat, so that there is a problem of a slow reduction speed of temperature of the seating surface of the seat.

### SUMMARY OF THE INVENTION

The present invention addresses at least one of the above disadvantages.

According to the present invention, there is provided an air conditioning system for a vehicle, including a seat part, an air conditioning unit, and a blower. The seat part supports buttocks of an occupant of the vehicle and includes a seating surface and an air flow passage. The occupant is seated on the seating surface. The air flow passage is inside the seat part. The air flow passage includes a suction port on the seating surface and an air outlet at a region of the seat part other than the seating surface. Air is suctioned through the suction port. The air conditioning unit includes a face air outlet and a lower air outlet, which is disposed on a lower side of the face air outlet in a vertical direction of the vehicle and through which conditioned air from the air conditioning unit is blown out toward the seating surface. The blower is configured to form a flow of air in the air flow passage from the suction port toward the air outlet. At a time of cooling an interior of the vehicle by the air conditioning unit, the conditioned air blown out of the lower air outlet is suctioned from the seating surface, and air that has passed through the air flow passage is blown out of the region of the seat part other than the seating surface, by the blower.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view illustrating a configuration of an air conditioning unit in accordance with a first embodiment of the invention;

FIG. 2 is a side view of a driver seat illustrating a state in which an air outlet and a seat blowing unit of the air conditioning unit of the first embodiment are disposed in a vehicle;

FIG. 3 is a block diagram illustrating an electric control part of an air conditioning system for the vehicle of the first embodiment;

FIG. 4 is a flow chart illustrating control content of an air-conditioning control device in FIG. 3;

FIG. 5 is a diagram illustrating a result of simulation of temperature decrease of a seating surface of a seat part of a seat unit in the first embodiment and first and second comparative examples;

FIG. 6 is a flow chart illustrating a part of control content performed by an air-conditioning control device in accordance with a second embodiment of the invention;

FIG. 7 is a flow chart illustrating a part of control content performed by an air-conditioning control device in accordance with a third embodiment of the invention;

FIG. 8 is a side view illustrating a driver seat in which a seat blowing unit in accordance with a fourth embodiment of the invention is disposed;

FIG. 9 is a top view illustrating a seat part of a seat unit in FIG. 8;

FIG. 10 is a side view illustrating a driver seat in which a seat blowing unit in accordance with a fifth embodiment of the invention is disposed;

FIG. 11 is a top view illustrating a seat part of a seat unit in FIG. 10; and

FIG. 12 is a sectional view taken along a line XII-XII in FIG. 10.

### DETAILED DESCRIPTION OF THE INVENTION

Embodiments of the invention will be described below with reference to the accompanying drawings. The same numerals are used in the drawings to indicate the same or equivalent parts in the following embodiments for the purpose of the simplification of the description.

### First Embodiment

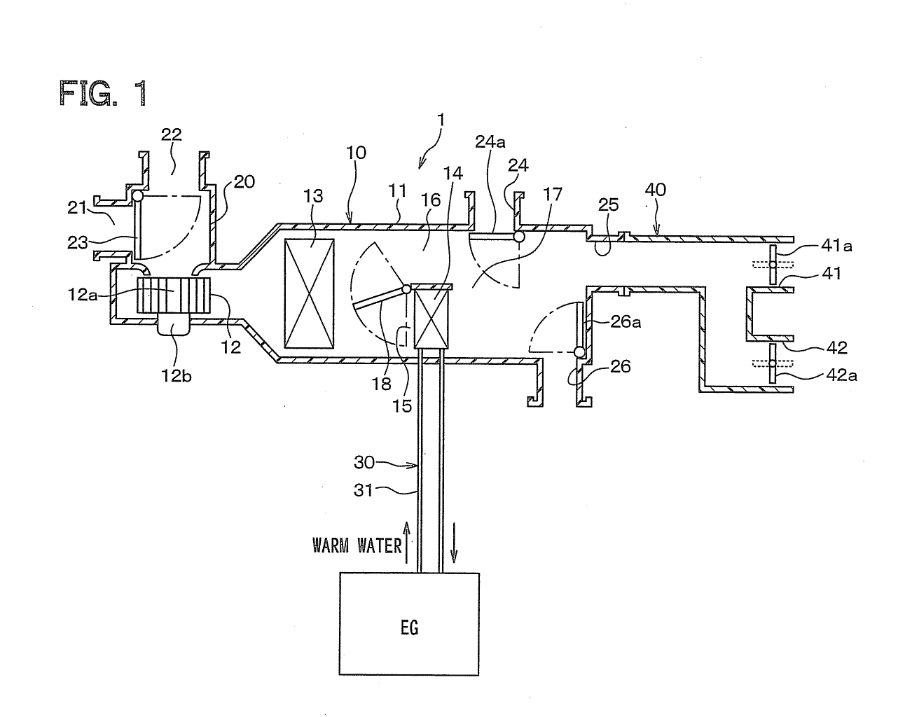

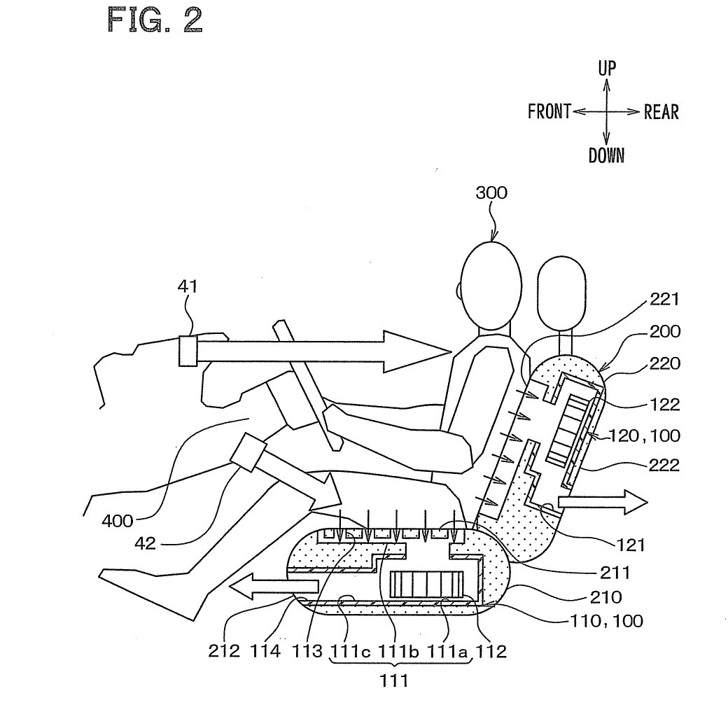

An entire configuration of an air conditioning unit 10 in accordance with a first embodiment of the invention is illustrated in FIG. 1. A side view of a driver seat of a vehicle, in which a seat blowing unit 100 of the first embodiment is disposed, is illustrated in FIG. 2. An air conditioning system 1 for the vehicle in the first embodiment includes the air conditioning unit 10 in FIG. 1 and the seat blowing unit 100 in FIG. 2.

The air conditioning unit 10 is disposed inside an instrument panel at a frontmost part of a vehicle interior. A blower 12, an evaporator 13, a heater core 14 and so forth are accommodated in a casing 11, which is an outer shell of the unit 10.

The casing 11 defines an air passage for air blown into the vehicle interior, and is formed from resin which has a certain level of resilience and is also excellent in strength. An inside-outside air switching box 20 that introduces inside air (air in the vehicle interior) and outside air (air outside the vehicle interior) in the manner of switching therebetween, is disposed on the uppermost stream side of the casing 11 in a flow direction of blowing air.

More specifically, the inside-outside air switching box 20 includes an inside air introduction port 21, through which inside air is introduced into the casing 11, and an outside air introduction port 22, through which outside air is introduced into the casing 11. An inside-outside air switch door 23, which changes an air volume rate between the air volume of inside air and the air volume of outside air, is disposed inside the inside-outside air switching box 20.

The blower 12 that blows air, which is suctioned through the inside-outside air switching box 20, toward the vehicle interior is disposed on a downstream side of the inside-outside air switching box 20 in an air flow direction. This blower 12 is an electric blower that drives a centrifugal multiblade fan 12a by an electric motor 12b.

The evaporator 13 is disposed on a downstream side of the blower 12 in the air flow direction. The evaporator 13 is a heat exchanger for cooling that cools blowing air through the exchange of heat between refrigerant flowing in the evaporator 13 and the blowing air. The evaporator 13 constitutes a refrigeration cycle together with a compressor, a condenser, a gas liquid separation device, and an expansion valve, which are not shown.

A cold air passage 15 for heating, through which air that has passed through the evaporator 13 flows, air passages such as a cold air bypass passage 16, and a mixing space 17 that mixes together air flowing out of the cold air passage 15 for heating and the cold air bypass passage 16, are formed on a downstream side of the evaporator 13 in the air flow direction.

The heater core 14 serving as a heating means for heating the air that has passed through the evaporator 13 is disposed in the cold air passage 15 for heating. The heater core 14 is a heat exchanger for heating. Specifically, the heater core 14 heats the air that has passed through the evaporator 13 by means of the exchange of heat between coolant of an engine EG, which outputs driving force for vehicle traveling, and the air that has passed through the evaporator 13. More specifically, a coolant passage 31 is provided between the heater core 14 and the engine EG, and the coolant passage 31 constitutes a coolant circuit 30, through which the coolant circulates between the heater core 14 and the engine EG.

The cold air bypass passage 16 is an air passage for guiding the air that has passed through the evaporator 13 into the mixing space 17 without passing this air through the heater core 14. Accordingly, temperature of the blowing air mixed in the mixing space 17 varies according to an air volume rate between the air passing through the cold air passage 15 for heating and the air passing through the cold air bypass passage 16.

In the present embodiment, an air mixing door 18 that continuously changes the air volume rate between the cold airs flowing into the cold air passage 15 for heating and the cold air bypass passage 16 is disposed on the downstream side of the evaporator 13 in the air flow direction as well as on inlet sides for the cold air passage 15 for heating and the cold air bypass passage 16.

A defroster opening 24, a face opening 25 and a foot opening 26, for blowing out temperature-controlled air from the mixing space 17 to the vehicle interior, which is an air conditioning object space, are formed at the most downstream part of the casing 11 in a blowing air flow direction.

A defroster duct (not shown) is connected to the defroster opening 24, and the conditioned air is blown out toward an inner surface of a windowpane on a front face of the vehicle through a defroster air outlet at a front end portion of this defroster duct. In the casing 11, a defroster door 24a that adjusts an opening area of the defroster opening 24 is disposed on an upstream side of the defroster opening 24 in the air flow direction.

A foot duct (not shown) is connected to the foot opening 26, and the conditioned air is blown out toward an underfoot part of an occupant of the vehicle through a foot air outlet at a front end portion of the foot duct. In the casing 11, a foot door 26a is disposed on an upstream side of the foot opening 26 in the air flow direction.

A face duct 40, which is made of resin and which defines an air passage from the face opening 25 to a face air outlet 41, is connected to the face opening 25. A face door 41a that adjusts a passage area of an air passage leading to the face air outlet 41 is provided for the face duct 40. The conditioned air is blown out toward an upper half of a body of the occupant in the vehicle interior through the face air outlet 41.

In addition to the air passage leading to the face air outlet 41, the face duct 40 includes a passage leading to a knee air outlet 42 and an opening-closing door 42a for the knee air outlet that opens or closes the knee air outlet 42. The knee air outlet 42 is an air outlet of the instrument panel that is formed near a knee of the occupant, and the outlet 42 will be described in greater detail hereinafter. The opening-closing door 42a for the knee air outlet is an opening adjustment means for adjusting an opening degree of the knee air outlet 42 through the adjustment of a passage area of the air passage leading to the knee air outlet 42.

These face door 41a, foot door 26a, and defroster door 24a constitute an air outlet mode door that switches between air outlet modes. For example, the doors 41a, 26a, 24a are coupled with an electric actuator for driving the air outlet mode door via a link mechanism (not shown) to be operated to rotate in synchronization.

The air outlet modes may include a face mode, in which the face air outlet 41 is fully opened to blow out air toward an upper half of the body of the occupant in the vehicle interior through the face air outlet 41; a bi-level mode, in which both the face air outlet 41 and the foot air outlet are opened to blow out air toward an upper half of the body and an underfoot part of the occupant in the vehicle interior; and a foot mode, in which the foot air outlet is fully opened and the defroster opening 24 is opened by a small opening degree to blow out air mainly through the foot air outlet. The face mode is selected at the time of air-conditioning cooling that blown-out air temperature is low, such as summer season.

The opening-closing door 42a of the knee air outlet 42 is operated by an electric actuator for driving the knee air outlet opening-closing door 42a.

An arrangement position of the knee air outlet 42 to the vehicle will be described.

As illustrated in FIG. 2, a seat unit 200, on which an occupant 300 is seated, includes a seat part 210 of the seat unit that holds the occupant's buttocks and a seat backrest part 220 that supports the occupant's back. An upper surface of the seat part 210 of the seat unit, on which the occupant 300 is seated, is a seating surface 211.

The knee air outlet 42 is located on a vehicle front side of the seat part 210, and disposed on a lower surface of a steering column 400 to be located between the seating surface 211 of the seat part 210 and the face air outlet 41 in a vehicle vertical direction.

The conditioned air is blown out toward the seating surface 211 of the seat part 210 through the knee air outlet 42. For example, the conditioned air is blown out in one direction toward a central part of the seating surface 211.

The seat blowing unit 100 will be described. The seat blowing unit 100 includes a first blowing unit 110 disposed inside the seat part 210 of the seat unit 200 and a second blowing unit 120 disposed inside the seat backrest part 220. Because the first blowing unit 110 and the second blowing unit 120 are similarly structured, only the first blowing unit 110 will be explained below.

The first blowing unit 110 includes an air flow passage 111 formed inside the seat part 210 and a blower 112 provided in the air flow passage 111.

The air flow passage 111 includes a suction port 113, through which air is suctioned, at a position of the seating surface 211 of the seat part 210, and has a seat air outlet 114 through which to blow out air toward the vehicle front at a position of a front surface 212 of the seat part 210. In the present embodiment, more than one suction port 113 are arranged throughout the whole region of the seating surface 211.

A seat surface material (not shown) having breathability is provided on the seating surface 211 of the seat part 210, and the air flow passage 111 is formed below the seat surface material. Thus, air is suctioned from the suction port 113 through the seat surface material.

The air flow passage 111 includes a blower accommodating part 111a, which accommodates the blower 112; a suction air passage 111b, which is on an upstream side of the blower 112 in the air flow direction, and along which air suctioned into the blower 112 through the suction port 113 flows; and a blow-out air passage 111c, which is on a downstream side of the blower 112 in the air flow direction, and through which air flows from the blower 112 toward the seat air outlet 114.

The suction air passage 111b is formed in a very cushion member constituting the seat part 210, and the blower accommodating part 111a and the blow-out air passage 111c are formed from a resin material similar to the casing 11 of the air conditioning unit 10. The member constituting the air flow passage 111 may be arbitrarily changed.

The blower 112 creates an air flow from the suction port 113 toward the seat air outlet 114 through the air flow passage 111. In the present embodiment, a centrifugal blower having a multiblade fan is employed for the blower 112. Revolving-speed control of a fan including a stop of the fan is performed upon the blower 112 by an air-conditioning electronic control unit (ECU) 60 which is described in greater detail hereinafter.

Similar to the first blowing unit 110, the second blowing unit 120 includes an air flow passage 121 disposed inside the seat backrest part 220 and a blower 122 disposed in the air flow passage 121.

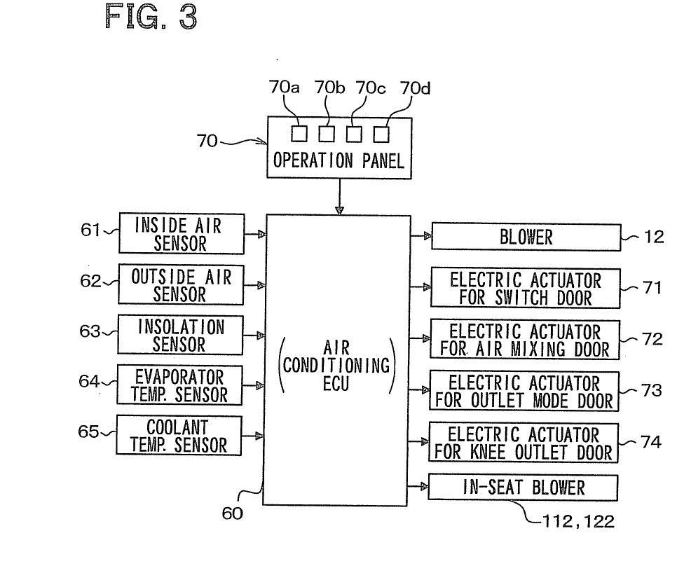

The air conditioning system 1 for the vehicle of the present embodiment includes an air-conditioning control device (air-conditioning ECU) 60 serving as a control means, as illustrated in FIG. 3.

The air-conditioning control device 60 is composed of a widely-known microcomputer including a central processing unit (CPU), a read-only memory (ROM), and a random access memory (RAM), and its peripheral circuit. The control device 60 performs a variety of calculations and processings based on an air-conditioning control program stored in the ROM. By outputting a control signal, the control device 60 controls operations of various devices connected to its output side.

The various devices may include the blower 12 of the air conditioning unit 10, an electric actuator 71 for the inside-outside air switch door that drives the inside-outside air switch door 23, an electric actuator 72 for the air mixing door that drives the air mixing door 18, an electric actuator 73 for driving the air outlet mode door, an actuator 74 for driving the knee air outlet opening-closing door, the blowers 112, 122 in the seat unit, and so forth.

A group of sensors, such as an inside air sensor 61 that detects vehicle interior temperature Tr, an outside air sensor (outside air temperature detecting means) 62 that detects outside air temperature Tam, an insolation sensor 63 that detects the amount of insolation Ts in the vehicle interior, an evaporator temperature sensor (evaporator temperature detecting means) 64 that detects evaporator blow-out air temperature (evaporator temperature) TE, which is temperature of air blown out of the evaporator 13, and a coolant temperature sensor 65 that detects engine coolant temperature TW, are connected to an input side of the air-conditioning control device 60.

Furthermore, various air-conditioning operating switches, which are arranged on an operation panel 70 disposed near the instrument panel at a front part of the vehicle interior, are connected to the input side of the air-conditioning control device 60. Specifically, the various air-conditioning operating switches arranged on the panel 70 may include an operating switch (not shown) for the air conditioning system 1 for the vehicle, an air-conditioning switch 70a that switches between turning on and off of air-conditioning, an auto-switch 70b that sets and deactivates automatic control of the air conditioning system 1 for the vehicle, a changeover switch (not shown) for operation modes, a suction port mode switch (not shown) that switches between suction port modes, an air outlet mode switch (not shown) that switches between the air outlet modes, an air volume setting switch (not shown) for the blower 12, a vehicle interior temperature setting switch 70c that sets the vehicle interior temperature, and an economy switch 70d that outputs a command, which prioritizes power saving of the refrigeration cycle.

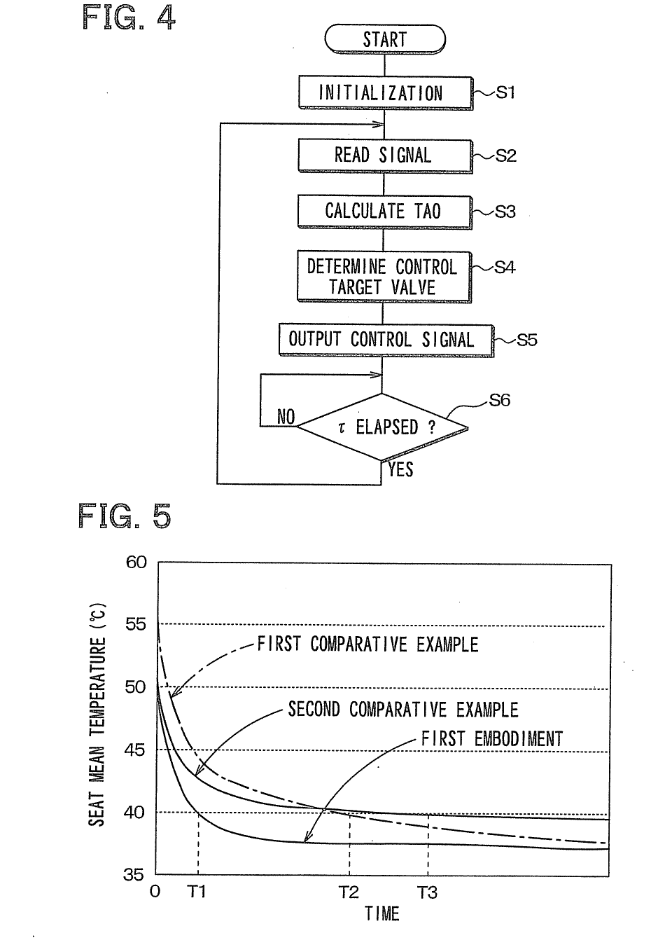

In reference to FIG. 4, operation of the air conditioning system 1 for the vehicle having the above-described configuration will be described. FIG. 4 is a flow chart illustrating control processing for the air-conditioning control device 60.

At S1, initialization of a flag and timer, initial position adjustment of a stepping motor, which constitutes the above-described electric actuator, and so forth, are carried out.

At S2, the control device 60 loads an operation signal of the operation panel 70, or signals of a vehicle environment state used for air-conditioning control, i.e., detection signals from the above-described group of sensors 61 to 65 and so forth, and then control proceeds to S3. Specifically, the operation signal may include vehicle interior set temperature Tₛₑₜ set by the vehicle interior temperature setting switch 70c, a selection signal for the air outlet mode, a selection signal for the suction port mode, and a setting signal for the air volume of the blower 12.

At S3, a target blow-out temperature TAO of air blown out into the vehicle interior is calculated. The target blow-out temperature TAO is calculated based on environmental heat loads, such as the set temperature and the vehicle interior temperature. Specifically, the temperature TAO is calculated by the following equation F1

TAO=Kₛₑₜ×Tₛₑₜ−Kr×Tr−Kam×Tam−Ks×Ts+C (F1)

“Tₛₑₜ” is the vehicle interior set temperature set by the vehicle interior temperature setting switch 70c; “Tr” is the vehicle interior temperature (inside air temperature) detected by the inside air sensor 61; “Tam” is outside air temperature detected by the outside air sensor 62; and “Ts” is the amount of insolation detected by the insolation sensor 63. “Kₛₑₜ”, “Kr”, “Kam”, “Ks” are control gains, and “C” is a constant for correction.

At S4, control target values for the various devices connected to the air-conditioning control device 60, e.g., blown air volume (blower level) of the blower 12, the suction port mode, the air outlet mode, an opening degree of the air mixing door 18, actuation or stop of the blowers 112, 122 inside the seat unit 200, and so forth, are determined based on the target blow-out temperature TAO.

Specifically, at the time of air-conditioning cooling, at which the target blow-out temperature TAO is lower than a predetermined temperature, the air outlet mode is determined to be the face mode; and a position of the opening-closing door 42a for the knee air outlet is determined to be in an appropriate direction in which the conditioned air is blown out through the knee air outlet 42, and actuation of the blowers 112, 122 inside the seat unit 200 is determined. In the present embodiment, the opening-closing door 42a for the knee air outlet and the blowers 112, 122 inside the seat unit 200 are determined constantly in this manner at the time of air-conditioning cooling.

At times other than the time of air-conditioning cooling, the position of the opening-closing door 42a for the knee air outlet is determined to be a position at which to stop blow-out of the conditioned air from the knee air outlet 42, and stops of the blowers 112, 122 inside the seat unit 200 is determined.

At S5, control signals are outputted to the various devices connected to the air-conditioning control device 60 so as to obtain the control target value determined at S4. Accordingly, the various devices connected to the control device 60 are activated.

At S6, control stands by for a control period τ, and control returns to S2 upon determination of elapse of the control period τ.

As described above, as performed at S4 in FIG. 4, at the time of air-conditioning cooling, the air-conditioning control device 60 determines the position of the opening-closing door 42a for the knee air outlet to be the position, at which the conditioned air is blown out through the knee air outlet 42; and the control device 60 determines actuation of the blowers 112, 122 inside the seat unit 200.

Consequently, as indicated by an arrow in FIG. 2, the conditioned air from the air conditioning unit 10 is blown out from the knee air outlet 42 toward the seating surface 211 of the seat part 210. This conditioned air is air obtained by cooling the blowing air through the evaporator 13, and is cold air having a lower temperature than vehicle interior air.

In the seat part 210 of the seat unit 200, as indicated by arrows in FIG. 2, by the blower 112, the conditioned air from the knee air outlet 42 is suctioned through the suction port 113 on the seating surface 211, and the air that has passed through the air flow passage 111 is blown out from the seat air outlet 114 on the front surface 212 of the seat part 210 toward the vehicle front.

As above, in the present embodiment, air is suctioned through the seating surface 211 of the seat part 210, and the air that has flowed inside the seat part 210 is discharged from the front surface 212 of the seat part 210, which is a region other than the seating surface 211. Accordingly, instead of the air affected by heat mass of the seat part 210, the air not affected by the heat mass of the seat part 210 can be supplied to the seating surface 211 of the seat part 210.

Moreover, the conditioned air is blown out from the knee air outlet 42 located near the seat part 210 toward the seating surface 211 of the seat part 210. Thus, the seating surface 211 can suction air having lower temperature than the air in the vehicle interior.

As a result, as illustrated in FIG. 5, in the present embodiment, in the early stage of the cooling-down period in summer, the temperature of the seating surface 211 of the seat part 210 can be promptly lowered.

A result of simulation of reduction in temperature of the seating surface 211 of the seat part 210 in the present embodiment and first and second comparative examples is illustrated in FIG. 5. A vertical axis of FIG. 5 indicates mean temperature of the whole region of the seating surface 211, and a horizontal axis of FIG. 5 indicates an elapsed time from the start of air-conditioning cooling.

In the first comparative example, the first blowing unit 110 of the present embodiment is changed, such that the air flow is reversed in the unit 110 of the present embodiment; and the conditioned air from the air conditioning unit 10 is suctioned directly through a duct connecting the air flow passage 111 inside the seat part 210 and the air conditioning unit 10, and air is blown out from the seating surface 211.

In the second comparative example, the first blowing unit 111 inside the seat part 210 of the seat unit 200 is similar to the present embodiment. The second comparative example is different from the present embodiment in that the knee air outlet 42 is removed. More specifically, in the second comparative example, the conditioned air is blown out toward the upper half of the body of the occupant from the face air outlet 41, so that the vehicle interior air is cooled, and the cooled vehicle interior air is suctioned from the seating surface 211 of the seat part 210. As illustrated in FIG. 5, a time taken for the mean temperature of the surface 211 to reach 40° C. from 55° C. at the start of air-conditioning cooling is a time T1 in the present embodiment, and is times T2, T3 longer than the time T1 in the first and second comparative examples. Therefore, it is found that the temperature can be more promptly lowered in the present embodiment than in the first and second comparative examples.

In addition, since the temperature can be more promptly lowered in the present embodiment than in the second comparative example, by providing the knee air outlet 42 on the lower surface of the steering column 400, which is closer to the seating surface 211 of the seat part 210 than the face air outlet 41, separately from the face air outlet 41, a greater temperature lowering effect can be produced in comparison to a case in which the conditioned air is blown out simply from the face air outlet 41.

Through the adjustment of a direction of a grille of the face air outlet 41 at a lower direction, cold air can be blown out from the face air outlet 41 toward the seating surface 211 of the seat part 210. However, in this case, the cold air cannot be blown out to the upper half of the body of the occupant, and the occupant's sense of air-conditioning cooling is thereby undermined. For this reason, as in the present embodiment, the knee air outlet 42 needs to be provided separately from the face air outlet 41.

In the seat backrest part 220 as well, as illustrated in FIG. 2, the conditioned air from the face air outlet 41 is suctioned from the seating surface 221 of the seat backrest part 220 by means of the second blowing unit 120, and the air that has flowed inside the seat backrest part 220 is discharged from a rear face 222 of the seat backrest part 220, which is a region other than the seating surface 221. Accordingly, instead of the air affected by heat mass of the seat backrest part 220, the conditioned air not affected by the heat mass of the seat backrest part 220 can be supplied to the seating surface 221 of the seat backrest part 220. Thus, in the early stage of the cooling-down period in summer, the temperature of the seating surface 221 of the seat backrest part 220 can be promptly lowered.

### Second Embodiment

A second embodiment of the invention is different from the first embodiment in that blow-out of conditioned air from a knee air outlet 42 is stopped in the case of satisfaction of a predetermined condition after the start of air-conditioning cooling, and this regard will be described below.

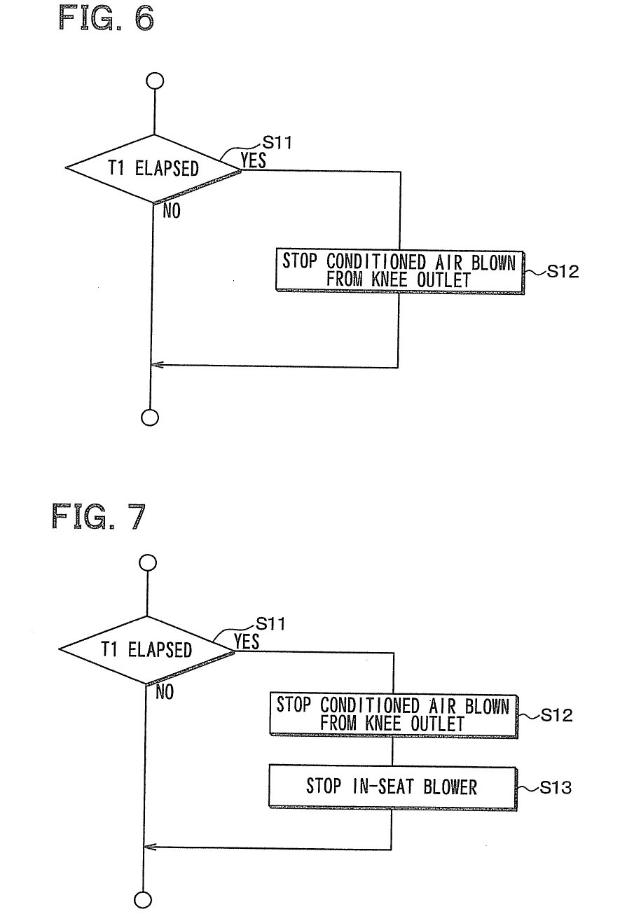

A flow chart for control performed by an air-conditioning control device 60 of the present embodiment is illustrated in FIG. 6. The control illustrated in FIG. 6 is carried out at the time of air-conditioning cooling when a target blow-out temperature TAO is lower than a predetermined temperature at S4 in FIG. 4.

At S11, the air-conditioning control device 60 determines whether a certain time has elapsed from immediately after the start of air-conditioning cooling. This certain time is set at the time T1 in FIG. 5, for example. If the certain time has elapsed, at S12, a position of an opening-closing door 42a for a knee air outlet is determined as a position at which to close the knee air outlet 42. Therefore, the stop of blow-out of the conditioned air from the knee air outlet 42 is determined. Then, procedures at S5, S6 in FIG. 4 are performed.

Consequently, when the certain time elapses from the start of air-conditioning cooling, a supply of the conditioned air to a seating surface 211 of a seat part 210 of a seat unit 200 through the knee air outlet 42 is stopped. Meanwhile, blowers 112, 122 inside the seat unit 200 remain in an operating state.

At stationary time at which the certain time has elapsed from the start of air-conditioning cooling and temperature in the vehicle interior is stabilized, if a knee of an occupant 300 or the seating surface 211 of the seat part 210 is overcooled by the conditioned air from the knee air outlet 42, the occupant feels uncomfortable.

In the present embodiment, when the certain time has elapsed from the start of air-conditioning cooling, the blow-out of the conditioned air from the knee air outlet 42 is stopped, thereby not giving the occupant discomfort feeling due to overcooling.

In the present embodiment, when the certain time has elapsed from the start of air-conditioning cooling, the stop of blow-out of the conditioned air from the knee air outlet 42 is determined. Alternatively, if the other conditions are satisfied after the start of air-conditioning cooling, the stop of blow-out of the conditioned air from the knee air outlet 42 may be determined.

For example, in a case of the target blow-out temperature TAO being higher than a predetermined threshold value, or in a case of the temperature of the seating surface 211 of the seat part 210 being lower than a predetermined threshold value, the stop of blow-out of the conditioned air from the knee air outlet 42 may be determined. If the temperature of the seating surface 211 of the seat part 210 is used as a criterion for the determination, for example, a temperature sensor may be provided in a suction air passage 111b, and the temperature of the seating surface 211 of the seat part 210 may be indirectly detected by this temperature sensor. This is because the air flowing through the suction air passage 111b is influenced by the temperature of the seating surface 211. Additionally, a temperature sensor may be provided on a reverse side of the seating surface 211 of the seat part 210, and the temperature of the seating surface 211 may be directly detected.

In the present embodiment, the blow-out of the conditioned air from the knee air outlet 42 is stopped. Alternatively, volume of conditioned air blown out of the knee air outlet 42 may be lowered. Specifically, at S12, the position of the opening-closing door 42a for the knee air outlet is determined to be a position, at which an opening degree of the door 42a is smaller than the fully open state, from a fully open position. In this manner as well, an effect similar to the present embodiment can be produced.

### Third Embodiment

A flow chart of control performed by an air-conditioning control device 60 in accordance with a third embodiment is illustrated in FIG. 7. In the present embodiment, as illustrated in FIG. 7, a procedure at S13 is added to the control in FIG. 6 described in the second embodiment.

In the present embodiment, similar to the second embodiment, after execution of the procedure at S12, the stop of blowers 112, 122 in the seat unit is determined at S13. Then, procedures at S5, S6 in FIG. 4 are performed.

As a result, when the certain time elapses from the start of air-conditioning cooling, blow-out of conditioned air from a knee air outlet 42 is stopped, and the blower 112 in a seat part 210 of a seat unit 200 is stopped.

Despite the stop of the blow-out of the conditioned air from the knee air outlet 42, temperature of a seating surface 211 of the seat part 210 decreases when the blower 112 in the seat part 210 is in operation.

In the present embodiment, when the certain time has elapsed from the start of air-conditioning cooling, the blower 112 inside the seat part 210 is stopped in addition to the stop of blow-out of the conditioned air from the knee air outlet 42. Accordingly, an effect of preventing the overcooling of the seating surface 211 of the seat part 210 can be further enhanced than in the second embodiment. In addition, by also stopping the blower 122 inside a seat backrest part 220, overcooling of a seating surface 221 of the seat backrest part 220 can be prevented.

In the present embodiment, when the certain time has elapsed from the start of air-conditioning cooling, the stop of blow-out of the conditioned air from the knee air outlet 42 is determined. Alternatively, similar to the description in the second embodiment, if the other conditions are satisfied after the start of air-conditioning cooling, the stop of blow-out of the conditioned air from the knee air outlet 42 may be determined.

In the present embodiment, the blow-out of the conditioned air from the knee air outlet 42 is stopped. Alternatively, similar to the description in the second embodiment, volume of conditioned air blown out of the knee air outlet 42 may be lowered.

In the present embodiment, the blower 112 inside the seat part 210 is stopped. Alternatively, the blown-air volume may be weakened through the reduction of a rotational speed of the blower 112 compared to the time of the start of air-conditioning cooling. In this manner as well, an effect similar to the present embodiment can be produced.

### Fourth Embodiment

A fourth embodiment of the invention is different from the first embodiment in respect of a position of a suction port 113 at a seat part 210 of a seat unit 200 and a direction of an air flow through a suction air passage 111b, and these points will be described below.

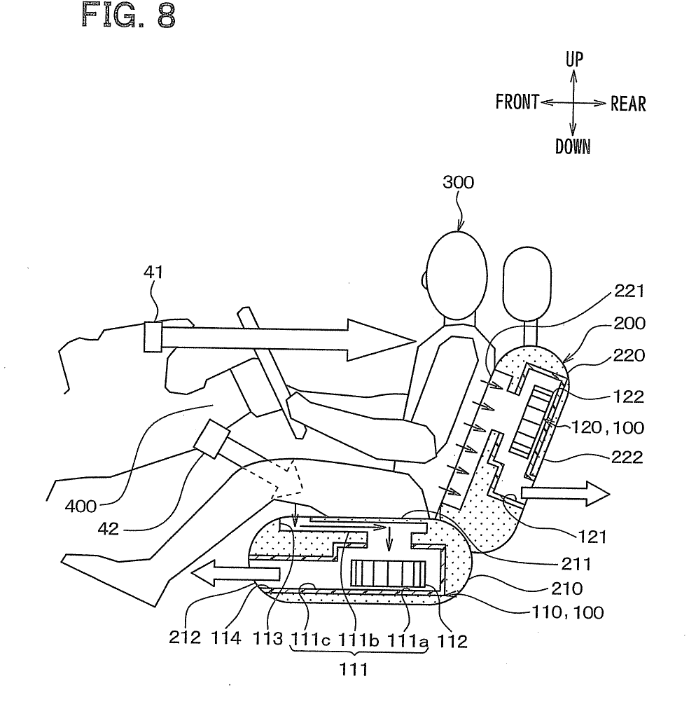

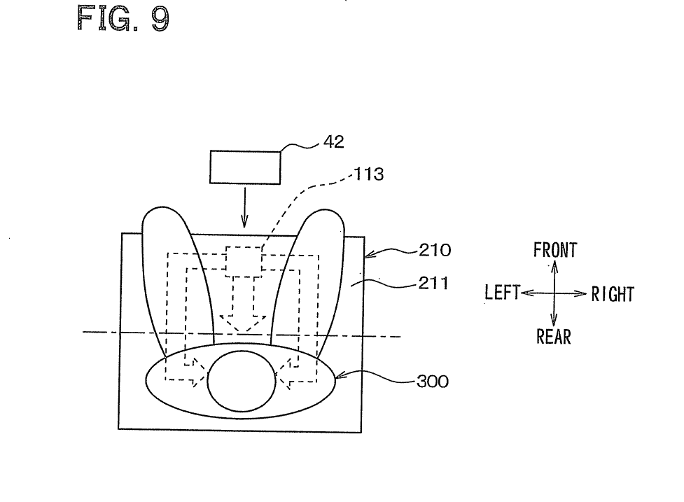

A side view and top view of a driver seat, in which a seat blowing unit 100 of the present embodiment is disposed, are illustrated in FIGS. 8 and 9. An alternate long and short dash line indicated in FIG. 9 is a central line passing through the center of a seating surface 211 of a seat part 210 of a seat unit 200 in a vehicle front-rear direction.

As illustrated in FIGS. 8 and 9, a suction port 113 is formed at a front part of the seating surface 211 of the seat part 210 on a vehicle front side of the center of the surface 211 in the vehicle front-rear direction.

As illustrated in FIG. 9, buttocks of an occupant 300 are generally located at a rear part of the seating surface 211 of the seat part 210 on a vehicle rear side of the center of the seating surface 211. As illustrated in FIG. 8, generally, thighs of the occupant 300 are away from the seating surface 211 of the seat part 210 due to his/her pedal operation. Thus, the front part of the seating surface 211 of the seat part 210 on the vehicle front side of the center of the surface 211 can be referred to as a region that is not in contact with the seated occupant.

As illustrated in FIG. 9, a specific position of the suction port 113 of the present embodiment is the front part of, the front part, central part, and rear part obtained as a result of dividing the seat part 210 equally among three in its front-rear direction. This specific position of the suction port 113 is a central part of the seat part 210 in the right-left direction in the case of dividing the seat part 210 equally among three in its right-left direction. The position of the suction port 113 is also a position between both the thighs of the occupant 300. As illustrated in FIG. 8, in an air flow passage 111 inside the seat part 210, the suction air passage 111b is located on a seating surface-side of the inner part of the seat part 210. As indicated by arrows in FIG. 8 and arrows with a short dashes line in FIG. 9, an air flow passage, through which the air suctioned from the suction port 113 flows rearward of the vehicle along the seating surface 211, is formed.

As illustrated in FIG. 9, a direction of blow-out of conditioned air from a knee air outlet 42 is one direction toward the suction port 113 of the seat part 210. The direction of blow-out of conditioned air from the knee air outlet 42 may also be V-shaped two directions as long as it is the direction toward the suction port 113 of the seat part 210.

As described above, in the present embodiment, the suction port 113 is formed at a region of the seating surface 211 of the seat part 210 that is not in contact with the seated occupant. Accordingly, the conditioned air from the knee air outlet 42 can be efficiently suctioned.

Furthermore, in the present embodiment, the air suctioned from the suction port 113 flows rearward of the vehicle along the seating surface 211. As a result, in addition to the reduction of temperature of the portion of the seating surface 211, at which the suction port 113 is located, temperature of a region of the seating surface 211 except the suction port 113 can also be reduced.

### Fifth Embodiment

A fifth embodiment of the invention is different from the first and fourth embodiments in the respects of a position of a suction port 113 on a seat part 210 of a seat unit 200 and of a direction of an air flow through a suction air passage 111b, and these points will be described below.

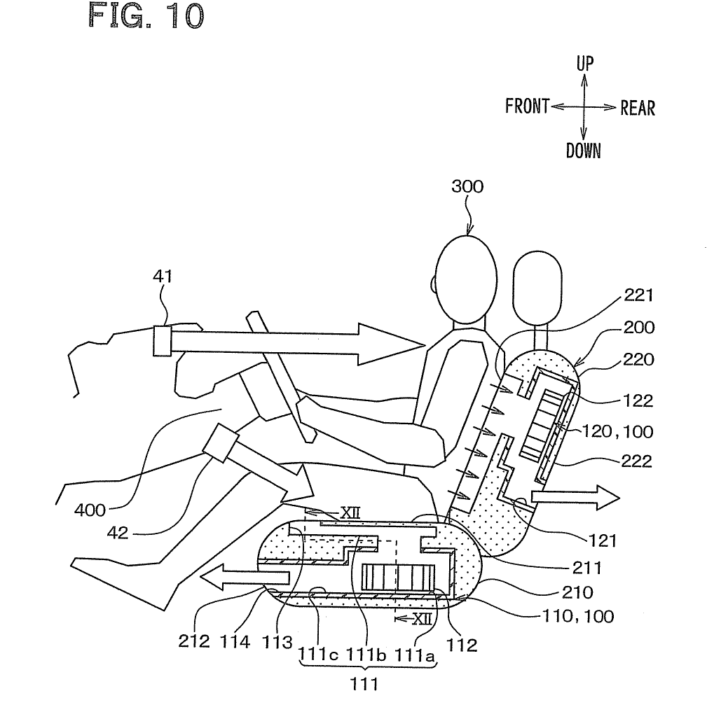

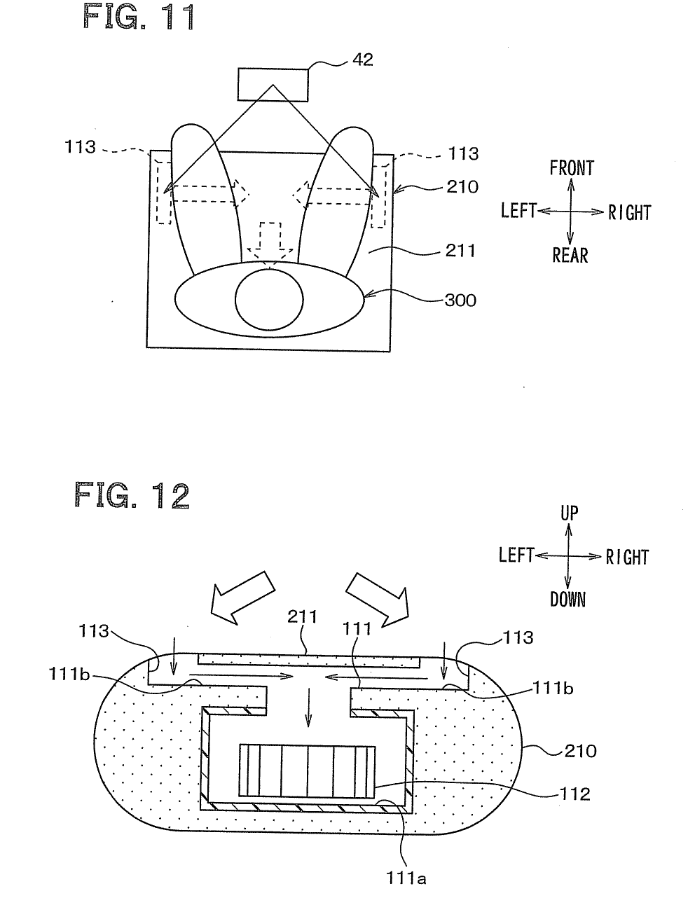

A side view and top view of a driver seat, in which a seat blowing unit 100 of the present embodiment is disposed, are illustrated in FIGS. 10 and 11. A sectional view taken along a line XII-XII in FIG. 10 is illustrated in FIG. 12. As illustrated in FIGS. 11 and 12, the suction ports 113 are arranged at both ends of a seating surface 211 of the seat part 210 in the vehicle right-left direction.

A width of the seat part 210 in the vehicle right-left direction is larger than an occupant 300 of standard size. Accordingly, both the ends of the seating surface 211 in the vehicle right-left direction can be referred to as regions that are not in contact with the occupant 300.

As illustrated in FIG. 11, specific positions of the suction ports 113 of the present embodiment are at both the end portions of the seating surface 211 in the vehicle right-left direction. Furthermore, the specific positions of the suction ports 113 are at regions of the seat part 210 on a vehicle front side of the center, and are also located outward of thighs of the occupant 300.

In an air flow passage 111 inside the seat part 210, the suction air passage 111b is located on the seating surface 211-side of the inner part of the seat part 210. As indicated by arrows with a short dashes line in FIG. 11 and arrows in FIG. 12, passages, through which the air suctioned from the suction port 113 flows toward the center of the seat part 210 along the seating surface 211, are formed.

As illustrated in FIG. 11, the directions of blow-out of conditioned air from a knee air outlet 42 are V-shaped two directions toward the suction ports 113 formed at both the end portions of the seat part 210 in the vehicle right-left direction. In addition, a louver provided inside the knee air outlet 42 or a guide member having a shape extending from the knee air outlet 42 into the vehicle interior may be used for such a means for defining the direction of air. As a result of such a configuration of the seat part 210, in the present embodiment, as indicated by the arrows in FIG. 11, the conditioned air from the knee air outlet 42 provided on the vehicle front side of the seat part 210 passes by above knees and thighs of the occupant 300, and then, the conditioned air is suctioned from the suction port 113 of the seat part 210. For this reason, in the present embodiment, because the conditioned air flows above the knees and thighs of the occupant 300, comfortableness for the occupant 300 can be improved in comparison to the first embodiment.

The conditioned air suctioned from the suction port 113 flows toward the center of the seat part 210 in the vehicle right-left direction along the seating surface 211. As a result, in addition to the reduction of temperature of the portion of the seating surface 211, at which the suction port 113 is located, temperature of a region of the seating surface 211 except the suction port 113 can also be reduced.

In the present embodiment, the suction ports 113 are formed at both the end portions of the seating surface 211 in the vehicle right-left direction as well as at the regions of the seat part 210 on the vehicle front side of the center. Alternatively, the suction port 113 may be provided throughout the whole region of both end portions of the seating surface 211 in the vehicle front-rear direction. Moreover, instead of at both the end portions of the seating surface 211 in the vehicle right-left direction, the suction port 113 may be formed only at either one end portion of them.

Modifications of the above embodiments will be described below. In the above-described embodiments, the knee air outlet 42 is provided on the lower surface of the steering column 400. However, the position of the knee air outlet 42 may be changed to another position, as long as it is a position at which the conditioned air can be blown out toward the suction port 113 formed on the seating surface 211 of the seat part 210.

In the case of the application of the invention to a passenger seat of the vehicle, for example, the position of the knee air outlet 42 may be set at a position on the vehicle front side of the seat part 210 as well as between the seating surface 211 of the seat part 210 and the face air outlet 41 in the vehicle up-down direction.

Also, the position of the knee air outlet 42 may be set at a position on a lateral side of the seat part 210, such as a door or center console, and the conditioned air may be blown out from the lateral side of the seat part 210 toward the suction port 113.

In the above embodiments, the air, which has flowed through the interior of the seat part 210, is blown out from the seat air outlet 114 formed on the front surface 212 of the seat part 210. Alternatively, the seat air outlet 114 may be formed at another position as long as the air can be blown out from a region of the seat part 210 other than the seating surface 211. For example, the seat air outlet 114 may be formed on a back surface of the seat part 210, and the air can be blown out toward under a rear seat of the vehicle.

In the above embodiments, the blower 112 is accommodated inside the seat part 210. Alternatively, the blower 112 may be provided outside the seat part 210. In this case, as in each of the above embodiments, an air flow passage inside the seat part 210 should have a suction port for air on the seating surface 211, and have an air outlet at a region of the seat part 210 other than the seating surface, such as a lower surface of the seat part 210. The air, which has flowed from an air outlet located outside the seat part 210 through the interior of the seat part 210, is blown out through the air outlet of the seat part 210. As a result, similar to the above embodiments, the air, which has flowed through the interior of the seat part 210, is blown out from the region of the seat part 210 other than the seating surface 211. Thus, effects similar to the above embodiments are produced.

The above-described embodiments may be suitably combined within a feasible range. For example, the fourth embodiment and the fifth embodiment may be combined together. Specifically, the suction port 113 on the seat part 210 may be formed at regions of the seating surface 211 of the seat part 210 between both the thighs of the occupant 300 and outward of both the thighs of the occupant 300. In this case, the directions of blow-out of conditioned air from the knee air outlet 42 may be three directions toward the respective suction ports 113.

To sum up, the air conditioning system 1 for a vehicle in accordance with the above-described embodiments may be described as follows.

The air conditioning system 1 for a vehicle includes a seat part 210, an air conditioning unit 10, and a blower 112. The seat part 210 supports buttocks of an occupant 300 of the vehicle and includes a seating surface 211 and an air flow passage 111. The occupant 300 is seated on the seating surface 211. The air flow passage 111 is inside the seat part 210. The air flow passage 111 includes a suction port 113 on the seating surface 211 and an air outlet 114 at a region of the seat part 210 other than the seating surface 211. Air is suctioned through the suction port 113. The air conditioning unit 10 includes a face air outlet 41 and a lower air outlet 42, which is disposed on a lower side of the face air outlet 41 in a vertical direction of the vehicle and through which conditioned air from the air conditioning unit 10 is blown out toward the seating surface 211. The blower 112 is configured to form a flow of air in the air flow passage 111 from the suction port 113 toward the air outlet 114. At a time of cooling an interior of the vehicle by the air conditioning unit 10, the conditioned air blown out of the lower air outlet 42 is suctioned from the seating surface 211, and air that has passed through the air flow passage 111 is blown out of the region of the seat part 210 other than the seating surface 211, by the blower 112.

Accordingly, the conditioned air having lower temperature than the vehicle interior air is supplied to the seating surface 211 of the seat part 210, without the supply of the air affected by the heat mass of the seat unit 200 to the seating surface 211 of the seat part 210. Therefore, the temperature of the seating surface 211 can be promptly lowered.

The air conditioning unit 10 may further include an opening adjustment means 42a for adjusting an opening degree of the lower air outlet 42. The air conditioning system 1 may further include a control means 60 for controlling operation of the opening adjustment means 42a and the blower 112. At a start of cooling the interior of the vehicle, the control means 60 opens the lower air outlet 42 by the opening adjustment means 42a and makes the blower 112 start to create the flow of air. After the start of cooling the interior of the vehicle, the control means 60 makes the opening adjustment means 42a reduce the opening degree of the lower air outlet 42 or close the lower air outlet 42 upon satisfaction of a predetermined condition.

Accordingly, after the start of cooling operation, in the case of satisfaction of the predetermined condition, the conditioned air from the air outlet 42 is lowered or the blow-out of conditioned air from the air outlet 42 is stopped, thereby not giving the occupant discomfort feeling due to overcooling.

After the start of cooling the interior of the vehicle, the control means 60 reduces air volume of the blower 112 upon the satisfaction of the predetermined condition.

In this manner, in the case of satisfaction of the predetermined condition after the start of air-conditioning cooling, an effect of preventing the overcooling can be enhanced through the reduction of the air volume of the blower 112 in addition to the above-described invention.

The air conditioning system 1 may further include a temperature sensor that is configured to detect temperature of the seating surface 211. The satisfaction of the predetermined condition may include one of: elapse of a certain period of time after the start of cooling the interior of the vehicle; a target blow-out temperature TAO of the conditioned air blown out from the air conditioning unit 10 being higher than a threshold value; and the temperature detected by the temperature sensor being lower than a threshold value.

The suction port 113 may be formed on a part of the seating surface 211 that is not in contact with the seated occupant 300. The air flow passage 111 may further include a flow passage 111b in an interior portion of the seat part 210 on a seating surface 211-side. The air suctioned through the suction port 113 may flow through the flow passage 111b along the seating surface 211.

The suction port 113 may be formed on the part of the seating surface 211 further on a vehicle front side than a center of the seating surface 211. The air suctioned through the suction port 113 may flow toward a rear side of the vehicle in the flow passage 111b along the seating surface 211.

The suction port 113 may be formed at an end portion of the seating surface 211 in a right-left direction of the vehicle. The air suctioned through the suction port 113 may flow toward a center of the seat part 210 in the right-left direction of the vehicle along the seating surface 211 in the flow passage 111b.

The suction port 113 may be formed at both end portions of the seating surface 211 in the right-left direction of the vehicle. The lower air outlet 42 may be disposed on a vehicle front side of the seat part 210. The conditioned air from the air conditioning unit 10 may be blown out in V-shaped two directions toward the suction port 113 through the lower air outlet 42.

The lower air outlet 42 may be disposed at a steering column 400 of the vehicle.

The air flow passage 111 may include a seat air outlet 114 at the region 212 of the seat part 210 other than the seating surface 211. The air that has passed through the air flow passage 111 may be blown out of the seat air outlet 114 to the interior of the vehicle.

Additional advantages and modifications will readily occur to those skilled in the art. The invention in its broader terms is therefore not limited to the specific details, representative apparatus, and illustrative examples shown and described.

What is claimed is:

1. An air conditioning system for a vehicle, comprising:
a seat part that supports buttocks of an occupant of the vehicle and includes:
a seating surface on which the occupant is seated; and
an air flow passage inside the seat part, wherein the air flow passage includes a suction port on the seating surface and an air outlet at a region of the seat part other than the seating surface, air being suctioned through the suction port;
an air conditioning unit that includes a face air outlet and a lower air outlet, which is disposed on a lower side of the face air outlet in a vertical direction of the vehicle and through which conditioned air from the air conditioning unit is blown out toward the seating surface; and
a blower that is configured to form a flow of air in the air flow passage from the suction port toward the air outlet, wherein at a time of cooling an interior of the vehicle by the air conditioning unit, the conditioned air blown out of the lower air outlet is suctioned from the seating surface, and air that has passed through the air flow passage is blown out of the region of the seat part other than the seating surface, by the blower.

2. The air conditioning system according to claim 1, wherein the air conditioning unit further includes an opening adjustment means for adjusting an opening degree of the lower air outlet, the air conditioning system further comprising a control means for controlling operation of the opening adjustment means and the blower, wherein:
at a start of cooling the interior of the vehicle, the control means opens the lower air outlet by the opening adjustment means and makes the blower start to create the flow of air; and
after the start of cooling the interior of the vehicle, the control means makes the opening adjustment means reduce the opening degree of the lower air outlet or close the lower air outlet upon satisfaction of a predetermined condition.

3. The air conditioning system according to claim 2, wherein after the start of cooling the interior of the vehicle, the control means reduces air volume of the blower upon the satisfaction of the predetermined condition.

4. The air conditioning system according to claim 2, further comprising a temperature sensor that is configured to detect temperature of the seating surface, wherein the satisfaction of the predetermined condition includes one of:
elapse of a certain period of time after the start of cooling the interior of the vehicle;
a target blow-out temperature of the conditioned air blown out from the air conditioning unit being higher than a threshold value; and
the temperature detected by the temperature sensor being lower than a threshold value.

5. The air conditioning system according to claim 1, wherein:
the suction port is formed on a part of the seating surface that is not in contact with the seated occupant;
the air flow passage further includes a flow passage in an interior portion of the seat part on a seating surface-side; and
the air suctioned through the suction port flows through the flow passage along the seating surface.

6. The air conditioning system according to claim 5, wherein:
the suction port is formed on the part of the seating surface further on a vehicle front side than a center of the seating surface; and
the air suctioned through the suction port flows toward a rear side of the vehicle in the flow passage along the seating surface.

7. The air conditioning system according to claim 5, wherein:
the suction port is formed at an end portion of the seating surface in a right-left direction of the vehicle; and
the air suctioned through the suction port flows toward a center of the seat part in the right-left direction of the vehicle along the seating surface in the flow passage.

8. The air conditioning system according to claim 7, wherein:
the suction port is formed at both end portions of the seating surface in the right-left direction of the vehicle;
the lower air outlet is disposed on a vehicle front side of the seat part; and
the conditioned air from the air conditioning unit is blown out in V-shaped two directions toward the suction port through the lower air outlet.

9. The air conditioning system according to claim 1, wherein the lower air outlet is disposed at a steering column of the vehicle.

10. The air conditioning system according to claim 1, wherein:
the air flow passage includes a seat air outlet at the region of the seat part other than the seating surface; and
the air that has passed through the air flow passage is blown out of the seat air outlet to the interior of the vehicle.
